(19) United States
(12) Patent Application Publication
(10) Pub. No.: US 2011/0213841 A1
(43) Pub. Date: Sep. 1, 2011

(54) SYSTEM AND METHOD FOR GENERATING AN ELECTRONIC COMMUNICATION

(75) Inventor: Joseph E. McIsaac, Burlington, MA (US)

(73) Assignee: Reflexion Networks, Inc.

(21) Appl. No.: 12/666,871

(22) PCT Filed: Jun. 24, 2008
(86) PCT No.: PCT/US08/67959

§ 371 Date: Mar. 22, 2011

Related U.S. Application Data
(60) Provisional application No. 60/937,046, filed on Jun. 25, 2007.

(51) Int. Cl. G06F 15/16

(52) U.S. Cl. 709/206

(57) ABSTRACT

A system and method for generating an electronic communication having a message component and a digital medium component. The technology includes, for example, identifying, assembling and exchanging digital medium between parties to complement various forms of electronic communication (e.g., “electronic mail”, “instant messaging”, etc.) where messages are directed between participants using sender and recipient identifiers (e.g., to, from, etc.). To generate the electronic communication, a characteristic (e.g., property, content) of an electronic communication between two or more parties is determined. One or more digital medium components are received from one or more third party servers. The one or more digital medium components are determined by at least one of the one or more third party servers based on the characteristic. A modified electronic communication is generated based on the electronic communication and the one or more digital medium components.

### BACKGROUND

Electronic forms of communication, such as email and instant messaging, are ubiquitous in personal and business environments. While the range of hardware and software clients for these forms of communication are diverse, electronic messages tend to take place in an application that is dedicated—meaning isolated—to the creation, receipt, viewing and storage of messages.

Usually there is a context or relationship that exists between any two parties in a dialog. For example, messages may take place between providers, customers and colleagues in a business setting. For individuals, messages might be exchanged between friends, family or various affinity groups or communities in which the individual may be a member.

### SUMMARY

As a general overview, the Applicant's disclosure relates to computer networks and, more specifically, to a system and method for generating an electronic communication having a message component and a digital medium component. The technology includes, for example, identifying, assembling and exchanging digital medium between parties to complement various forms of electronic communication (e.g., “electronic mail”, “instant messaging”, etc.) where messages are directed between participants using sender and recipient identifiers (e.g., to, from, etc.). For some types of electronic communication, the components can also be referred to as payloads.

Electronic communication can be enhanced by opening up the dialog of messages to additional systems (e.g., third party systems), which may contribute additional content and functionality for the participants that is unavailable in current communication systems. The additional systems could contribute digital medium components (e.g., live controls, digital video content, etc.) to complement each electronic communication sent that is based on the characteristics (e.g., properties and content) of the electronic communication. The characteristic can include, for example, the context from the dialog and/or the relationship between the parties.

For example, consider email communications between buyers and sellers at an online auction house. There is a well-defined context for this dialog; one party is interested in purchasing an item being auctioned by the second party. Additional information about the buyer and seller, the item, and the terms and conditions of the transaction is typically accessed through a Web browser, independently from the client used to send and receive messages. It would be a great benefit if such information and links were made available during communication, specific to the respective parties and transaction details. For those involved in multiple auctions, this sort of information would greatly simplify the pursuit and management of many auctions, as the pertinent information is always present with each message.

As another example in a business context, consider a computer sales company. During a technical service email dialog between a customer and the company, it would be of great value if a complete description of the customer's computer system was included in the messages to the technician, as well as indications as to the availability of software and hardware updates for that system, or special offers for related products, as a few ideas. Perhaps a search engine for a knowledge base that was predefined for the customer's system would be helpful, as well.

As an additional example in a consumer context, among consumers so called “social networking” sites are accumulating large communities of users. Many sites (e.g., MySpace.com, Facebook.com) offer messaging services that employ proprietary protocols that tend to reduce or eliminate the use of traditional, standard email by site users. The accompaniment of an HTML payload with additional content and links about the individual—perhaps a link to a MySpace.com page, a photo of the individual or a link to an instant messenger channel—might bring social networking users back to email as a custom payload has much of the same appeal driving social networking site adoption. It gives individuals the opportunity to express themselves, only this time with email.

As another generic example, email messages contain a great deal of information that is valuable to a variety of software applications. Frequently, it is difficult for applications to capitalize on the content of email messages because they are not provided access to the message. This results in inefficient or nonexistent integration of email into external software applications that otherwise would benefit from such integration.

In accordance with one aspect of the disclosure, there is a method for generating an electronic communication including a message content component and a digital medium component. The method includes determining a characteristic of an electronic communication between two or more parties. The method further includes receiving one or more digital medium components from one or more third party servers. The one or more digital medium components are determined by at least one of the one or more third party servers based on the characteristic. The method further includes generating a modified electronic communication based on the electronic communication and the one or more digital medium components.

In accordance with another aspect of the disclosure, there is a computer program product for generating an electronic communication including a message content component and a digital medium component. The computer program product is tangibly embodied in an information carrier and includes instructions being operable to cause a data processing apparatus to determine a characteristic of an electronic communication between two or more parties. The computer program product further includes instructions being operable to cause a data processing apparatus to receive one or more digital medium components from one or more third party servers. The one or more digital medium components are determined by at least one of the one or more third party servers based on the characteristic. The computer program product further includes instructions being operable to cause a data processing apparatus to generate a modified electronic communication based on the electronic communication and the one or more digital medium components.

In accordance with another aspect of the disclosure, there is a system for generating an electronic communication including a message content component and a digital medium component. The system includes an electronic communication server. The electronic communication server includes an analysis module, an exchange module, and a generation module. The analysis module determines a characteristic of an electronic communication between two or more parties. The exchange module receives one or more digital medium components from one or more third party servers. The one or more digital medium components are determined by at least one of the one or more third party servers based on the characteristic. The generation module generates a modified electronic communication based on the electronic communication and the one or more digital medium components.

In accordance with another aspect of the disclosure, there is a system for generating an electronic communication including a message content component and a digital medium component. The system includes means for determining a characteristic of an electronic communication between two or more parties. The system further includes means for receiving one or more digital medium components from one or more third party servers. The one or more digital medium components are determined by at least one of the one or more third party servers based on the characteristic. The system further includes means for generating a modified electronic communication based on the electronic communication and the one or more digital medium components.

In accordance with another aspect of the disclosure, a system that is coupled to an electronic communications network that includes a receiver that receives an inbound message over the electronic communications network from a sender. The system selectively shares the characteristics (e.g., properties, content of messages, etc.) with one or more supplier systems (i.e., third party servers) before delivery of the message, each of which may supply digital medium that the system assembles into a form that is presentable to the recipient upon examination of the message. The inbound message can include an identifier that is associated with a sender, an identifier that is associated with a recipient, message content, and/or other elements related to the transfer medium for the message (e.g., “electronic mail SMTP header fields”).

In accordance with another aspect of the disclosure, the system determines which supplier systems are given access to which elements of each message, and/or which are permitted to supply digital medium for inclusion in the payload, as well as the sequence in which two or more supplier systems are engaged in this manner. The system can, for example, control what properties and content of the message can be requested by or shared with each supplier system. The digital medium can optionally be assembled in accordance with a pre-defined template that indicates where each supplier system's digital medium shall reside within the payload during display. Optionally, the display location can be viewed in a form that is interpreted by the component-viewing client (e.g., email clients, Web browsers, stand-alone interface, etc.).

In some examples, any of the aspects above can include one or more of the following features. The modified electronic communication can be, for example, transmitted via a communications medium and/or viewed.

In some examples, the electronic communication is received from a communications medium. The electronic communication includes a message content component.

In other examples, the characteristic includes at least one of a property or a message content component. The electronic communication includes a part or all of a synchronous communication.

In some examples, the electronic communication includes a part or all of an asynchronous communication. The characteristic is transmitted to the one or more third party servers. The one or more third party servers is determined from a plurality of third party servers based on the characteristic. The one or more third party servers are pre-determined.

In other examples, the electronic communication and the one or more digital medium components are stored separately at a storage device. The electronic communication and the one or more digital medium components are retrieved from the storage device. The modified electronic communication is viewed. The modified electronic communication includes the electronic communication and the one or more digital medium components.

In some examples, the modified electronic communications is stored. The modified electronic communication includes the electronic communication and the one or more digital medium components. The one or more digital medium components are determined by at least one of the one or more third party servers based on a criterion associated with the third party server.

In other examples, the two or more parties include at least one sender and at least one receiver of the electronic communication. The modified electronic communication is assembled before a time of viewing by the receiver. The modified electronic communication is assembled at a time of viewing by the receiver. The one or more third party servers are not associated with the two or more parties.

In some examples, the one or more third party servers are separate from the electronic communication server. The exchange module transmits the characteristic to the one or more third party servers. The exchange module determines the one or more third party servers from a plurality of third party servers based on the characteristic.

In other examples, a storage device stores the electronic communication and the one or more digital medium components separately.

In some examples, a storage device stores the modified electronic communications. The modified electronic communication includes the electronic communication and the one or more digital medium components.

In some examples, the digital medium component is aggregated in the manner described while processing the initial delivery of the electronic communication to the recipient (referred to as a “static component”). The same digital medium component is displayed each time the modified electronic communication is viewed in this embodiment.

In other examples, the digital medium component is aggregated anew each time the modified electronic communication is viewed and/or refreshed (referred to as a “dynamic component”). A different digital medium component could be presented each time an electronic communication is viewed and/or refreshed in this embodiment.

In some examples, a continuous dialog connection is made during which multiple electronic communications are sent (e.g. an instant messenger session), the digital medium component can be aggregated at the start of the dialog, during, and/or after each electronic communication (referred to as a “session payload”).

In other examples, the digital medium component can include information and user-interface elements supplied by the participating supplier systems that may be context-sensitive to the respective message with which it is displayed.

In some examples, the product includes a callable interface that allows supplier systems to request and be granted (or denied) elements of the electronic communication that the supplier system would like to receive, ostensibly for use in the functional capability of the supplier system, and/or on which the content of the digital medium component depends for final inclusion in the modified electronic communication.

In other examples, one or more software tools are utilized to enable supplier systems to participate in this product. The one or more software tools can be used for choosing which supplier systems will be invoked for which messages (e.g., circumstances such as who is the sender, the recipient, the date/time, or some other element of the message or its content). The one or more software tools can pre-define a template layout for the digital medium component.

Additional advantages and aspects of the present disclosure will become readily apparent to those skilled in the art from the following detailed description, wherein various embodiments are shown and described, simply by illustrating the best mode contemplated for practicing the present invention. For example, along with describing a system, the disclosure also describes methodologies and computer product implementations. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram representing an exemplary electronic communications system;

FIGS. 2A-2B are flowcharts representing exemplary electronic communications in an electronic communications system;

FIG. 3 is a sequence diagram depicting exemplary steps and logic for processing a message in the system using a static digital medium component;

FIG. 4 is a depiction of an exemplary structure of an email message in RFC 2450 MIME format for supporting delivery and viewing of the digital medium component;

FIGS. 5A-5B are screenshots of exemplary modified electronic communications;

FIGS. 6A-6B are depictions of an exemplary instant messenger client that displays the URL that will display the corresponding digital medium component for the dialog;

FIGS. 7A-7B are screenshots of exemplary modified electronic communications; and

FIG. 8 is a flowchart representing electronic communication processing in the system.

### DETAILED DESCRIPTION

Generally, the system and method for generating an electronic communication (hereinafter “the product”) identifies and assembles information in digital format including computer-generated text, graphics, as well as photographs, animation, sound and video, interpretive mark-up languages and/or other formats (collectively as “digital medium”) based upon characteristics (e.g., a chosen context) of an electronic communication exchanged in an electronic communications network.

The product selectively shares characteristics (e.g., properties, content) of electronic communication passing through the communications network with one or more other systems (referred to as the “supplier applications” or “third party servers”), which systems may identify and supply the product with digital medium based upon the characteristics. An advantage is that the third party servers can utilize the shared characteristics to determine optimal digital medium for the individual recipient. In other words, two recipients of the same electronic communication can receive different digital medium since the characteristic can include individualized information about the recipient. The aggregate of digital medium provided by other systems (i.e., “the digital medium components”) is assembled and presented to the recipient at and/or before the time the message component of the electronic communication is viewed.

The product can be, for example, a gateway for the integration of applications and communications. Many software applications could benefit by having the content of electronic communication made available to them as they occur. Some example applications that could benefit are for security, message archiving, project management, customer support, sales lead generation and follow-up, and/or marketing campaign management, to name a few.

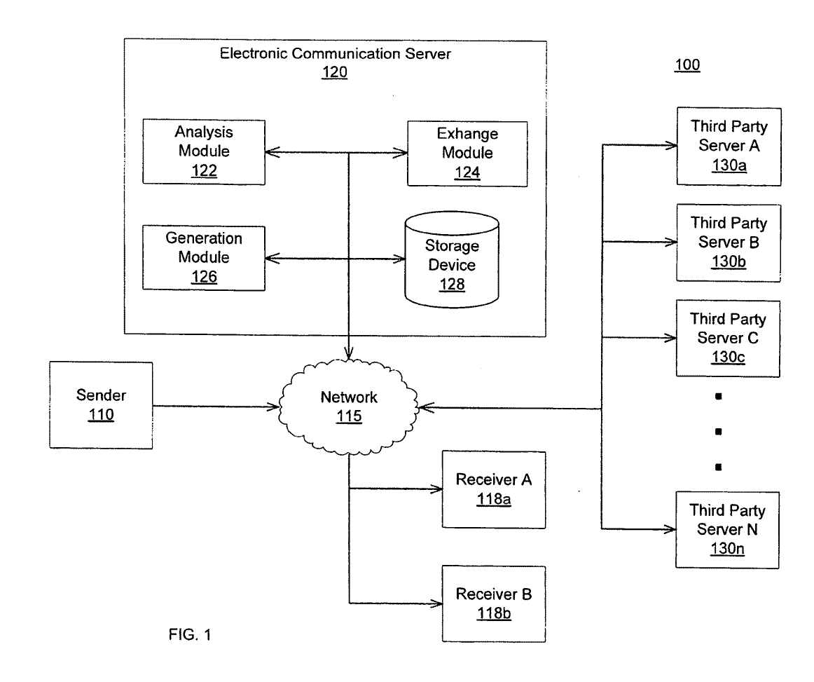

FIG. 1 is a block diagram representing an exemplary electronic communications system 100. The electronic communications system 100 includes a sender 110, a network 115, receivers A (118a) and B (118b) (generally 118), an electronic communications server 120, and third party servers A (130a), B (130b), C (130c), . . . , and N (130n) (generally 130). The electronic communications server 120 includes an analysis module 122, an exchange module 124, a generation module 126, and a storage module 128.

The sender 110 transmits an electronic communication (e.g., an email, an instant messaging request/response, a Web conferencing request/response, etc.) to one or more receivers A (118a) and/or B (118b) via a network 115. The electronic communication is received (e.g., intercepted, directed to, etc.) by the electronic communication server 120.

The analysis module 122 determines a characteristic (e.g., property, message content, time, message attributes, header information, protocol information, etc.) of the electronic communication between the sender 110 and receiver 118. The exchange module 124 transmits the characteristic to one or more of the third party servers 130 via the network 115. The one or more third party servers 130 determine one or more digital medium components based on the characteristic and/or a criterion associated with the third party server 130 (e.g., all receivers 118 associated with a free email account receive a certain video stream/clip; all registered users for a Website receive a digital medium with a free coupon, etc.). The one or more third party servers 130 transmit the one or more digital medium components to the exchange module 124.

The generation module 126 generates a modified electronic communication based on the electronic communication and the one or more digital medium components. The electronic communication server 120 can, for example, transmit the modified electronic communication to the receiver 118 via the network 115. In other examples, the receiver 118 views the modified electronic communication.

In some examples, the storage device 128 can store the modified electronic communication which includes the electronic communication and associated digital medium components. In other examples, the storage device 128 can store the electronic communication and associated digital medium components separately.

In some examples, the exchange module 124 determines the one or more third party servers 130 from a plurality of third party servers based on the characteristic of the electronic communication. For example, the plurality of third party servers include A (130a) through Z (not shown). The exchange module 124 includes preferences that third party servers A (130a) through T (not shown) receive the characteristic for all electronic communication associated with news and third party servers U (not shown) through Z receive the characteristic for all electronic communication associated with sports.

In other examples, the one or more third party servers 130 are pre-determined. For example, the plurality of third party servers include A (130a) through Z (not shown). The exchange module 124 includes preferences that third party servers A (130a) through T (not shown) receive the characteristic for all electronic communication between 8:00 AM and 12:00 PM and third party servers U (not shown) through Z receive the characteristic for all electronic communication for all other times.

In some examples, the modified electronic communication is assembled at a time of viewing by the receiver 118. For example, the message component and the digital medium component are stored separately by the storage device 128 and/or a storage device (not shown) associated with the receiver 118. When the receiver 118 requests viewing of the modified electronic communication, then the components are assembled by the electronic communication server 120 and/or by the receiver's email server (not shown).

In other examples, the modified electronic communication is assembled before the time of viewing by the receiver 118. For example, the message component and the digital medium component are assembled together and stored by the storage device 128 and/or a storage device (not shown) associated with the receiver 118. When the receiver 118 requests viewing of the modified electronic communication, then the pre-assembled components are retrieved from the storage device 128 and/or the storage device associated with the receiver.

Although FIG. 1 illustrates a sender 110 and receivers A (118a) and B (118b), the electronic communication system 100 can include any number of senders and/or receivers. For example, an instant message can include two senders and four receivers. As another example, an email can include one sender and fifty receivers. An advantage is that different digital medium can be associated with each receiver since the digital medium is determined based on the characteristic of the electronic message which includes individualized information for the receiver.

In some examples, the one or more third party servers 130 and the parties, sender 110 and receivers 118, are not associated with each other. As another example, the electronic communication server 120 and the one or more third party servers 130 are separate from each other. In other examples, the sender 110 and/or the receivers 118 can utilize any type of transmitting device to transmit, receive, and/or view electronic communication and parts thereof (e.g., message component, digital medium component, etc.).

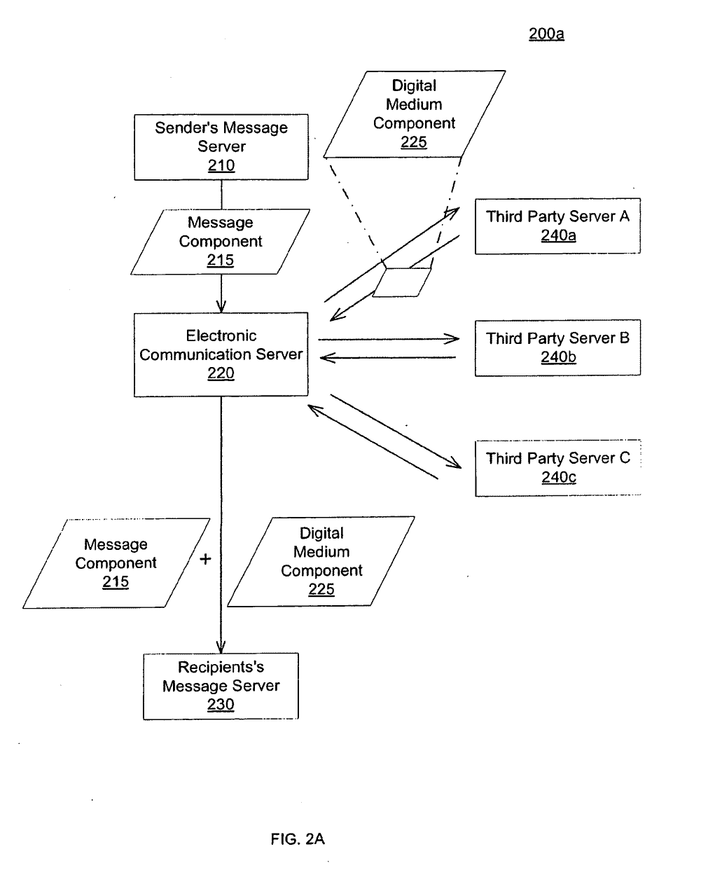

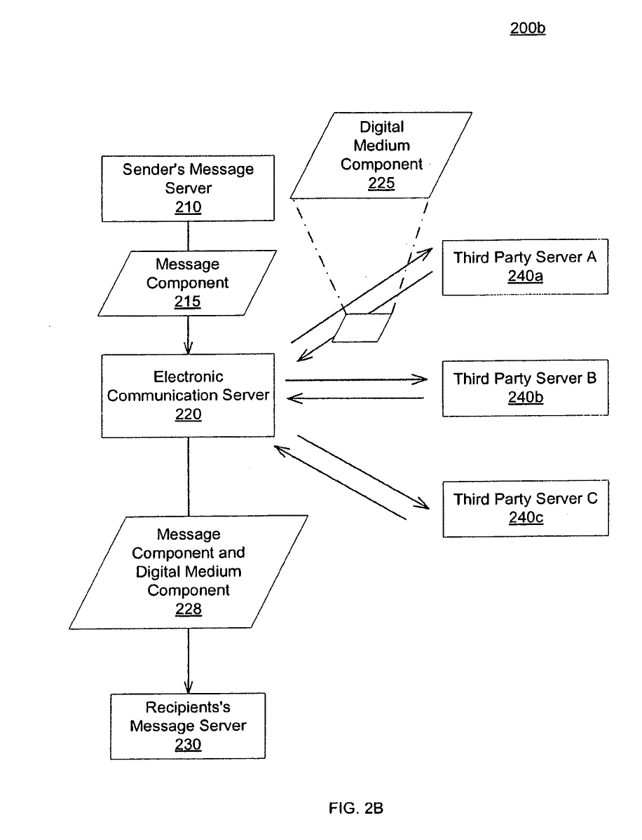

FIGS. 2A-2B are flowcharts representing exemplary electronic communications in an electronic communications system 200a and 200b. FIG. 2A illustrates a modified electronic communication with a separate message component and a separate digital medium component. FIG. 2B illustrates a modified electronic communication with an integrated message component and a digital medium component.

Referring to FIG. 2A, a sender's message server 210 transmits an electronic communication that includes a message component 215. The electronic communication server 220 receives the electronic communication and determines an attribute of the electronic communication. The electronic communication server 220 transmits the attribute to third party servers A (240a), B (240b), and C (240c).

In this example, the third party server A (240a) transmits a digital medium component 225 to the electronic communication server 220. In other examples, the third party servers B (240b) and C (240c) transmit other digital medium components to the electronic communication server 220.

The electronic communication server 220 receives the digital medium component 225 and generates a modified electronic communication based on the electronic communication and the digital medium component 225. The modified electronic communication includes the message component 215 and the digital medium component 225 which are transmitted, viewed, and/or stored separately. The modified electronic communication is transmitted to the recipient's message server 230 for viewing by the recipient.

Referring to FIG. 2B, the sender's message server 210 transmits the electronic communication that includes the message component 215. The electronic communication server 220 receives the electronic communication and determines an attribute of the electronic communication. The electronic communication server 220 transmits the attribute to third party servers A (240a), B (240b), and C (240c).

The electronic communication server 220 receives the digital medium component 225 and generates a modified electronic communication 228 based on the electronic communication and the digital medium component 225. The modified electronic communication 228 includes the message component 215 and the digital medium component 225 which are transmitted, viewed, and/or stored together. In other words, the message component 215 and the digital medium component 225 are associated together for transmission, viewing, and/or storage. The modified electronic communication 228 is transmitted to the recipient's message server 230 for viewing by the recipient.

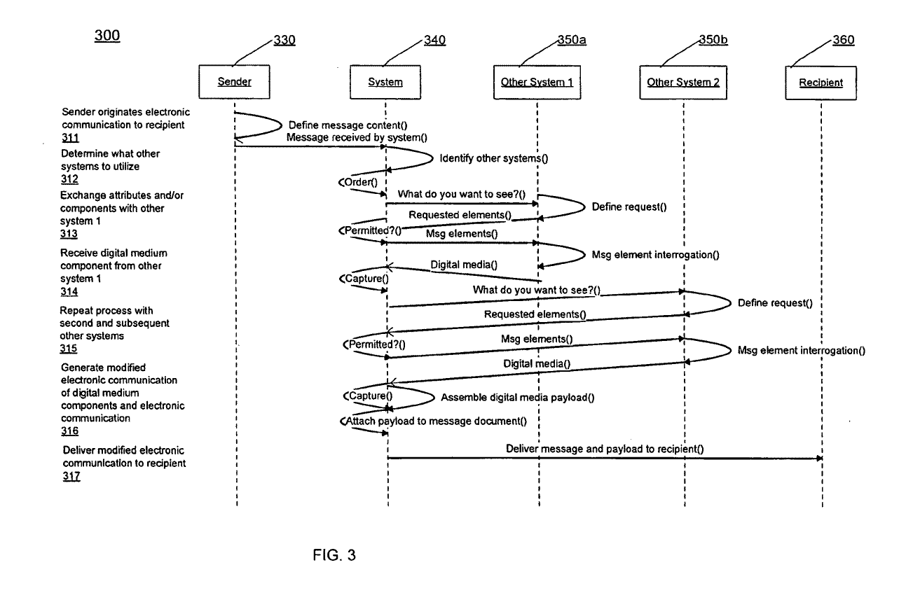

FIG. 3 is a sequence diagram 300 depicting exemplary steps and logic for processing a message in the system 340 using a static digital medium component. The sender 330 originates (311) an electronic communication to the recipient 360. The system 340 receives the electronic communication and determines (312) what other systems to utilize.

The system 340 exchanges (313) attributes and/or components with the other system 1 (350a) (i.e., third party server). The system 340 receives (314) a digital medium component from the other system 1 (350a). The system 340 repeats the process (315) with the other system 2 (350b) and any other systems (e.g., other system 3, other system 4, etc.). The system 340 generates (316) a modified electronic communication based on the digital medium components and the electronic communication. The system 340 delivers (317) the modified electronic communication to the recipient 360.

As illustrated in FIG. 3, the digital medium component is static. In other words, the digital medium component is determined once at the time of receipt by the system 340 and/or viewing by the recipient 360.

In other examples, the digital medium component is dynamic. In other words, the digital medium component is determined every time the recipient 360 views (e.g., requests, accesses, etc.) and/or refreshes the modified electronic communication. The modified electronic communication can be refreshed automatically (e.g., refreshed every thirty seconds, refreshed upon every mouse click in the window, etc.) and/or manually by the user. In this example, the system 340 reprocesses the electronic communication as illustrated by the sequence diagram 300.

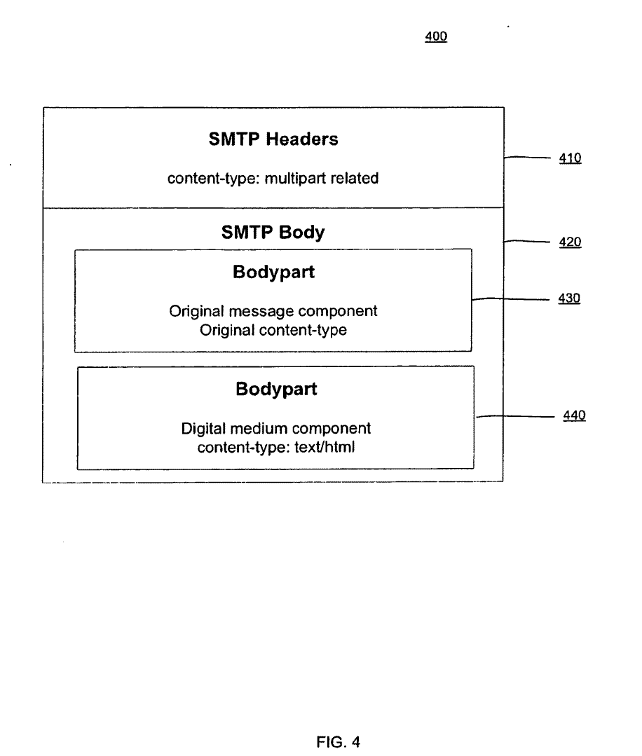

FIG. 4 is a depiction of an exemplary structure of an email message 400 in RFC 2450 MIME format for supporting delivery and viewing of the digital medium component. The email message 400 includes SMTP headers 410 and a SMTP body 420. the SMTP body 420 includes multiple body parts. The body parts include an original message component 430 and a digital medium component 440.

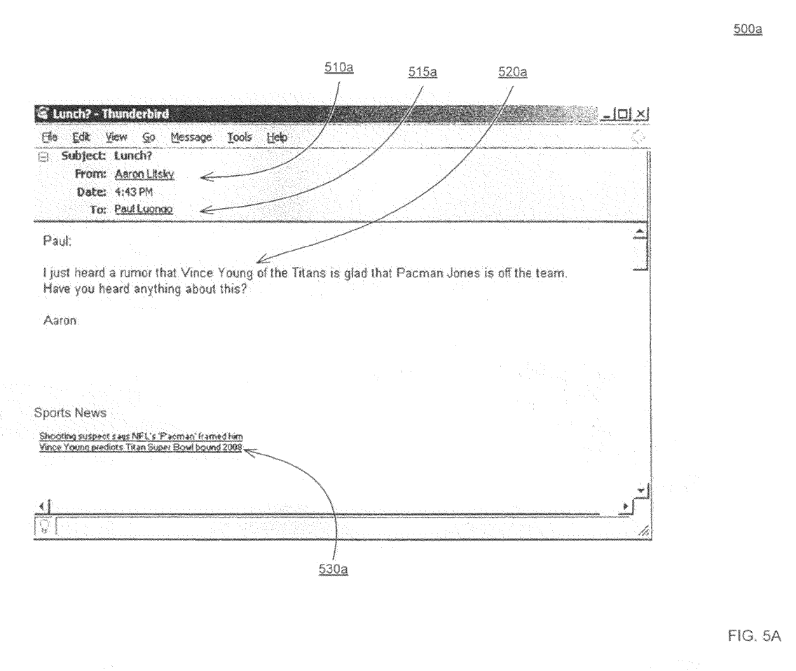

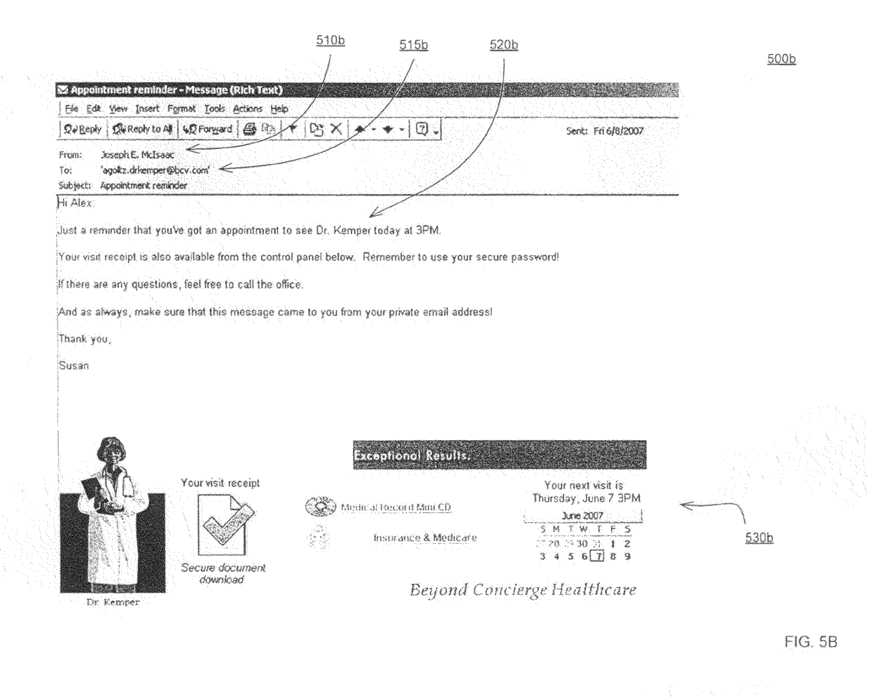

FIG. 5A is a screenshot of exemplary modified electronic communication 500a. The modified electronic communication 500a is an email message from Aaron Litsky 510a (i.e., sender) to Paul Luongo 515a (i.e., recipient). The modified electronic communication 500a includes a message component 520a and a digital medium component 530a.

Referring to FIGS. 1 and 5A, the sender 510a transmits an email message to the recipient 515a. The email message includes the message component 520a. The analysis module 122 determines a characteristic of the email message. In this example, the characteristics include the keywords: Vince Young, Titans, and Pacman Jones. The exchange module 124 transmits the characteristics to the third party servers 130. The third party server A (130a) which is associated with sports news transmits a digital medium component (in this example, a hyperlink to a video of the news article) to the exchange module 124. The generation module 126 generates the modified electronic communication 500a based on the electronic communication (in this example, the SMTP headers 510a and 515a and the message component 520a). The modified electronic communication 500a is viewed by Paul Luongo, the recipient 515a.

Referring to FIGS. 4 and 5A, the SMTP headers 410 includes the sender 510a, the recipient 515a information, the time, and other information associated with the email message. The original message component 430 corresponds with the message component 520a, and the digital medium component 440 corresponds with the digital medium component 530a.

FIG. 5B is a screenshot of exemplary modified electronic communication 500b. The modified electronic communication 500b is an email message from Joseph E. Mclsaac 510b (i.e., sender) to agoltz.drkemper@bcv.com 515b (i.e., recipient). The modified electronic communication 500b includes a message component 520b and a digital medium component 530b.

Referring to FIGS. 1 and 5B, the sender 510b transmits an email message to the recipient 515b. The email message includes the message component 520b. The analysis module 122 determines a characteristic of the email message. In this example, the characteristics include the keywords, Dr. Kemper and appointment, and the date of the email message. The exchange module 124 transmits the characteristics to the third party servers 130. The third party server B (130b) which is associated with medical information transmits a digital medium component (in this example, images and hyperlink to medical information) to the exchange module 124. The generation module 126 generates the modified electronic communication 500b based on the electronic communication (in this example, the SMTP headers 510b and 515b and the message component 520b).

The modified electronic communication 500b is viewed by agoltz.drkemper@bcv.com, the recipient 515a. The modified electronic communication 500b, i.e., the email message, can be viewed by the recipient 515a utilizing a standard email viewer, a proprietary message viewer, and/or any other type of electronic communication viewer.

As illustrated in FIGS. 5A and 5B, the electronic communication can be an asynchronous communication (i.e., email communication). In other examples, the electronic communication can be any type of asynchronous communication including a video message, a graphical message, etc.

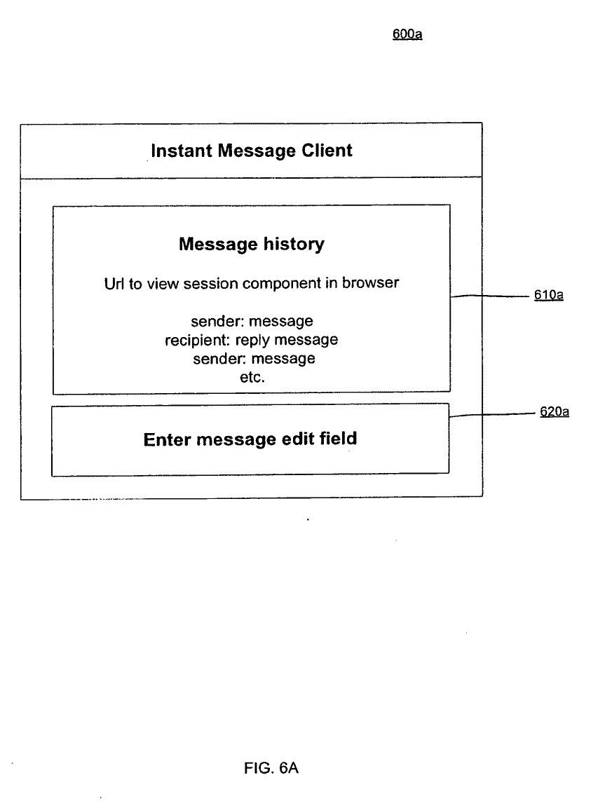

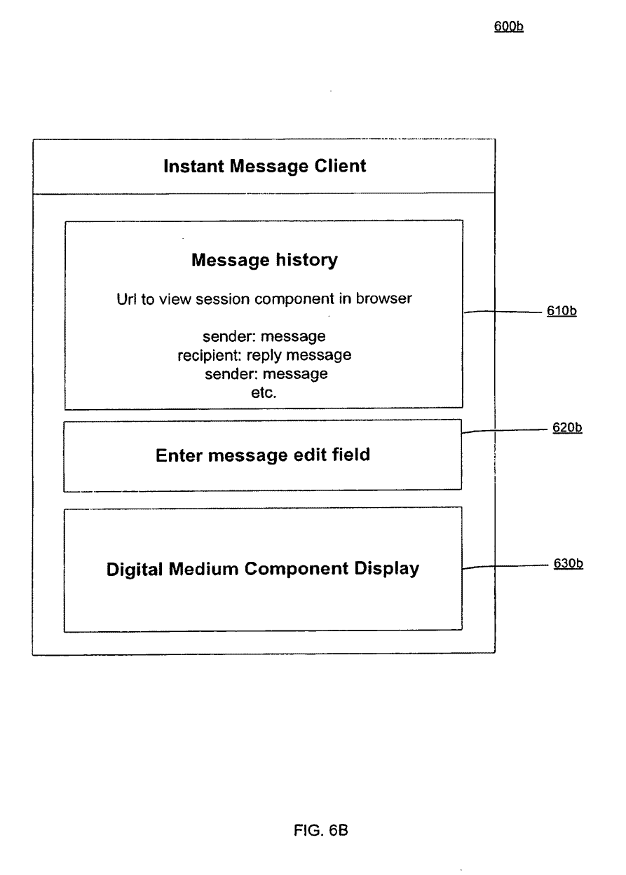

FIG. 6A is a depiction of an exemplary instant messenger client 600a. The instant messenger client 600a includes a message history 610a (e.g., sender message, recipient message, sender message, etc.) and a message edit field 620a.

FIG. 6B is a depiction of an exemplary instant messenger client 600b that displays the URL that will display the corresponding digital medium component for the dialog. The instant messenger client 600b includes a message history 610b (e.g., sender message, recipient message, sender message, etc.), a message edit field 620b, and a digital medium component display 630b.

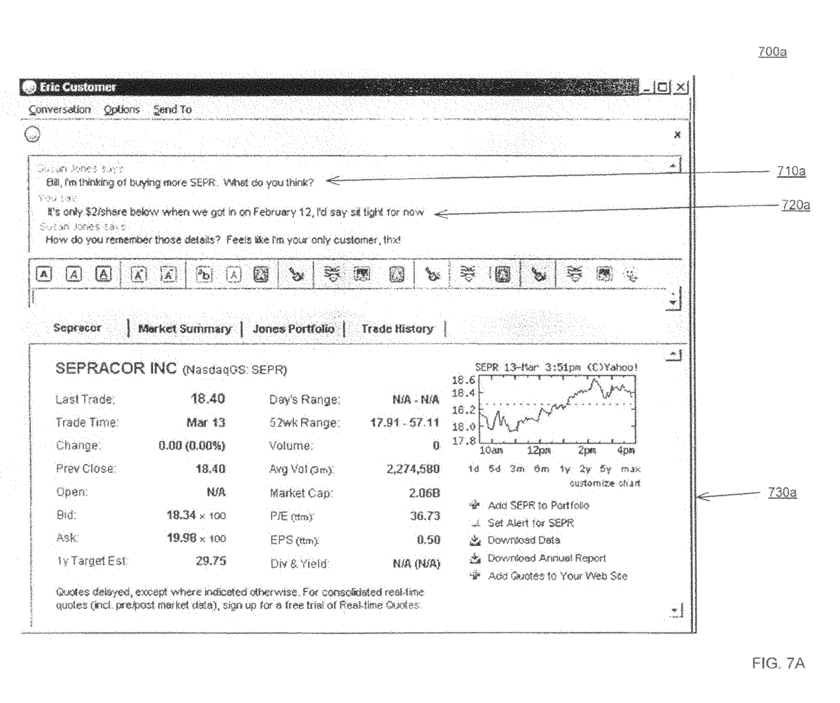

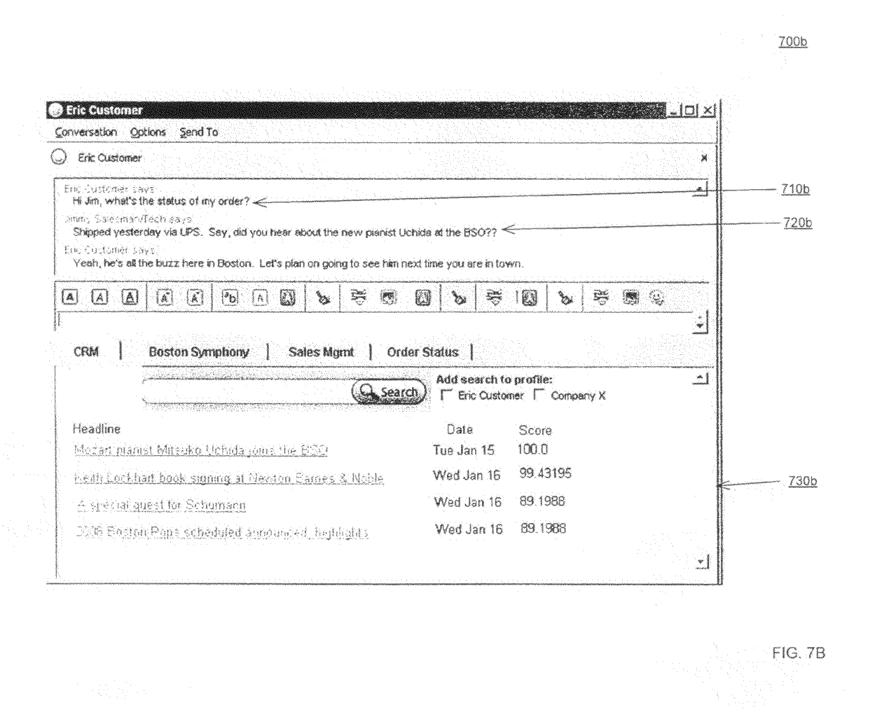

FIG. 7A is a screenshot of exemplary modified electronic communication 700a. The modified electronic communication 700a is an instant message chat between Susan Jones (i.e., sender, recipient, and then sender) and Eric Customer (i.e., recipient, sender, and then recipient). The modified electronic communication 700a includes message components 710a and 720a and a digital medium component 730a. In this example, the digital medium component 730a is a combination of text, graphics, and an interactive user interface.

Referring to FIGS. 1 and 7A, the sender transmits a message to the recipient. The message includes the message component. The analysis module 122 determines a characteristic of the message (in this example, “Bill, I′m thinking of buying more SEPR. What do you think?”). In this example, the characteristics include the keyword: SEPR. The exchange module 124 transmits the characteristics to the third party servers 130. The third party server C 130c which is associated with stock information transmits a digital medium component (in this example, a text, graphics, and an interactive user interface) to the exchange module 124. The generation module 126 generates the modified electronic communication 700a based on the electronic communication (in this example, the message components 710a and 720a). The modified electronic communication 700a is viewed by Eric Customer.

Referring to FIGS. 6B and 7A, the message history 610b includes the messages 710a and 720a. The digital medium component display 630b corresponds with the digital medium component 730a.

FIG. 7B is a screenshot of exemplary modified electronic communication 700b. The modified electronic communication 700b is an instant message chat between Eric Customer (i.e., sender, recipient, and then sender) and Jimmy Salesman/Tech (i.e., recipient, sender, and then recipient). The modified electronic communication 700b includes message components 710b and 720b and a digital medium component 730b. In this example, the digital medium component 730b is a combination of text, graphics, and an interactive user interface.

Referring to FIGS. 1 and 7B, the sender transmits a message to the recipient. The message includes the message component. The analysis module 122 determines a characteristic of the message (in this example, “Shipped yesterday via UPS. Say, did you hear about the new pianist Uchida at the BSO??”). In this example, the characteristics include the keywords: BSO, pianist, and Uchida. The exchange module 124 transmits the characteristics to the third party servers 130. The third party server B (130b) which is associated with news information transmits a digital medium component (in this example, a text, graphics, and an interactive user interface) to the exchange module 124. The generation module 126 generates the modified electronic communication 700b based on the electronic communication (in this example, the message components). The modified electronic communication 700b is viewed by Eric Customer.

As illustrated in FIGS. 7A and 7B, the electronic communication can be a synchronous communication (i.e., instant message communication). In other examples, the electronic communication can be any type of synchronous communication including a Web chat, a video conference, a Web conference, etc.

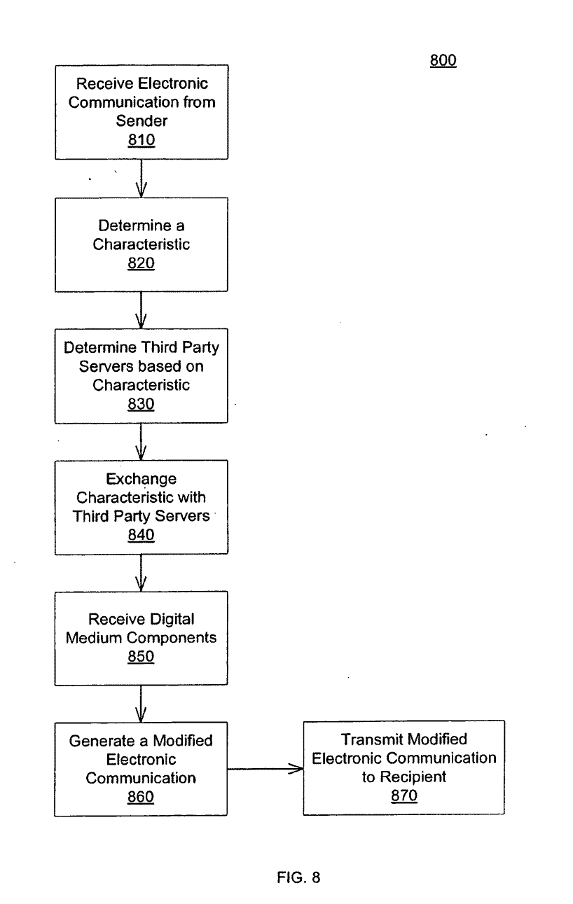

FIG. 8 is a flowchart 800 representing electronic communication processing in the system 100 of FIG. 1. The electronic communication server 120 receives (810) an electronic communication from a sender 110. The analysis module 122 determines (820) a characteristic of the electronic communication.

The exchange module 124 determines (830) one or more third party servers 130 from a plurality of third party servers based on the characteristic. The exchange module 124 exchanges (840) the characteristic with the determined third party servers 130. The exchange module 124 receives (850) digital medium components from the third party servers 130.

The generation module 126 generates (860) a modified electronic communication based on the electronic communication and the digital medium components (e.g., modified electronic communication 700b of FIG. 7B). The electronic communication server 120 transmits (870) the modified electronic communication to the recipient (e.g., receiver A (118a)).

In some examples, different hosts might use the product with different supplier applications. As described above, an online auction site might have a proprietary application that tracks buyers, sellers and auction items. Social networking sites might have supplier applications that reference chat rooms or online Web sites descriptive of the individual or their interests. Schools might have a calendar application to remind alumni to donate to the school or to attend upcoming reunions or other school activities. The range of potential supplier applications is limitless.

In other examples, supplier applications can have some static and/or live controls—collectively constituting its “user-interface”—to provide information to the recipient from the application that's related to the electronic communication.

In some examples, the utility and value of the product are that it facilitates the access and integration of supplier applications to the stream of electronic communication. The product can collect user-interface contributions from a variable assemblage of participating supplier applications and display the aggregate (i.e., the “digital medium component”) in an acceptable presentation (e.g., one that is easy to use and attractive by common user-interface design criteria) whenever the recipient views the respective source electronic communication.

In other examples, electronic messages are typically viewed through one or more client software applications. The product can, for example, present the modified electronic communication in a client-agnostic manner, depending on the type of communication. For client-agnostic payload display in email, the structure of the email is altered to employ the RFC 2045/2046 Multipurpose Internet Mail Extension (MIME) standards, which allow for content such as the digital medium to be added to the electronic communication itself, which then allows any MIME-compliant mail client to display the payload at the same time as the original message. Therefore, the preferred embodiment format for the digital medium provided by supplier applications is HTML. In other examples, certain email clients interpret MIME-structured email in different ways, so it's sometimes difficult to make a single electronic communication appear “correctly” in every client.

In some examples, the digital medium is made available from a server that can serve the digital medium which enables client agnostic instant messaging. The serving of the digital medium from a server resembles a typical HTML page, and includes in the IM stream a Universal Resource Locator (URL) that points to the page.

In other examples, when the client application can be employed, the digital medium can appear in the frame of the client, like in a payload HTML browser area within the client, thus relieving the need to modify the electronic communication. Usually, display of the digital medium through a client that anticipates receipt of a digital medium is less problematic than client agnostic approaches.

In some examples, the product connects to a Message Transport Agent (MTA), such as a mail server and/or IM server through an application integration protocol native to the MTA. For example, the email MTA qmail can pass mail through the “dot qmail” mechanism, from which the product could receive the message for processing as described herein. Another native integration protocol is the “Miller” interface for the email MTA Sendmail. The product must be passed a copy of the message, including any headers and content bodies, plus any transport information related to the communication medium, such as the identifier of the sender, recipient, sender server, date and time of the message, etc.

In other examples, the product identifies which supplier applications will be called, and the order in which they will be called, for a given message based on the identity of the sender, recipient, and/or the characteristic of the electronic communication.

In some examples, the product initiates communication with each supplier application, in turn. The first initiation could consist of a trigger event through any number of established methods for inter-process communication. The preferred embodiment employs a common method of inter-process communication known as “sockets”. The exact inter-process connection method is not important, as long as it is robust enough to permit the exchange of all information received from the MTA as described above.

In other examples, the characteristics (e.g., properties, content) required by the supplier application are transferred from the product to the supplier application, which will assess and process that information in any manner for which it was designed. Once the supplier application has completed its processing, it returns a success/failure status to the product, along with an HTML document that contains the digital medium to be included in the final electronic communication (e.g., modified electronic communication) delivered to the recipient.

In some examples, the product accrues each HTML block from all supplier applications, and then assembles a final digital medium component HTML that will either be added to the electronic communication itself, and/or stored in a database for synchronized display with the electronic communication through a message client that was built for such display.

In other examples, if the digital medium is embedded in an email message, the system will convert the message to one or more forms of multipart MIME messages, with the original message made into the first body part, and a second body part of type text/html added to contain the digital medium. The product can, for example, transmit the electronic communication and its digital medium to the recipient.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be communication provided to the user in any form of sensory feedback (e.g., visual feedback, auditory feedback, or tactile feedback). Input from the user can, for example, be received in any form, including text, acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

Examples of communication networks include wired networks, wireless networks, packet-based networks, and/or circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method for generating an electronic communication comprising a message content component and a digital medium component, the method comprising:
determining a characteristic of an electronic communication between two or more parties;
receiving one or more digital medium components from one or more third party servers, the one or more digital medium components being determined by at least one of the one or more third party servers based on the characteristic; and
generating a modified electronic communication based on the electronic communication and the one or more digital medium components.

2. The method of claim 1, further comprising transmitting the modified electronic communication via a communications medium.

3. The method of claim 1, further comprising viewing the modified electronic communication.

4. The method of claim 1, further comprising receiving the electronic communication from a communications medium, the electronic communication comprising a message content component.

5. The method of claim 1, wherein the characteristic comprises at least one of a property or a message content component.

6. The method of claim 1, wherein the electronic communication comprises a part or all of a synchronous communication.

7. The method of claim 1, wherein the electronic communication comprises a part or all of an asynchronous communication.

8. The method of claim 1, further comprising transmitting the characteristic to the one or more third party servers.

9. The method of claim 1, further comprising determining the one or more third party servers from a plurality of third party servers based on the characteristic.

10. The method of claim 1, wherein the one or more third party servers are pre-determined.

11. The method of claim 1, further comprising storing, at a storage device, the electronic communication and the one or more digital medium components separately.

12. The method of claim 11, further comprising:
retrieving, from the storage device, the electronic communication and the one or more digital medium components; and
viewing the modified electronic communication, the modified electronic communication comprising the electronic communication and the one or more digital medium components.

13. The method of claim 1, further comprising storing the modified electronic communications, the modified electronic communication comprising the electronic communication and the one or more digital medium components.

14. The method of claim 1, wherein the one or more digital medium components are determined by at least one of the one or more third party servers based on a criterion associated with the third party server.

15. The method of claim 1, wherein the two or more parties comprise at least one sender and at least one receiver of the electronic communication.

16. The method of claim 15, wherein the modified electronic communication is assembled before a time of viewing by the receiver.

17. The method of claim 15, wherein the modified electronic communication is assembled at a time of viewing by the receiver.

18. The method of claim 1, wherein the one or more third party servers are not associated with the two or more parties.

19. A computer program product, tangibly embodied in an information carrier, the computer program product including instructions being operable to cause a data processing apparatus to:
determine a characteristic of an electronic communication between two or more parties;
receive one or more digital medium components from one or more third party servers, the one or more digital medium components being determined by at least one of the one or more third party servers based on the characteristic; and
generate a modified electronic communication based on the electronic communication and the one or more digital medium components.

20. A system for generating an electronic communication comprising a message content component and a digital medium component, the system comprising:
an electronic communication server, the electronic communication server comprising:
an analysis module for determining a characteristic of an electronic communication between two or more parties;
an exchange module for receiving one or more digital medium components from one or more third party servers, the one or more digital medium components being determined by at least one of the one or more third party servers based on the characteristic; and
a generation module for generating a modified electronic communication based on the electronic communication and the one or more digital medium components.

21. The system of claim 20, wherein the one or more third party servers are separate from the electronic communication server.

22. The system of claim 20, wherein the exchange module further transmits the characteristic to the one or more third party servers.

23. The system of claim 20, wherein the exchange module further determines the one or more third party servers from a plurality of third party servers based on the characteristic.

24. The system of claim 20, further comprising a storage device for storing the electronic communication and the one or more digital medium components separately.

25. The system of claim 20, further comprising a storage device for storing the modified electronic communications, the modified electronic communication comprising the electronic communication and the one or more digital medium components.

26. A system for generating an electronic communication comprising a message content component and a digital medium component, the system comprising:
means for determining a characteristic of an electronic communication between two or more parties;
means for receiving one or more digital medium components from one or more third party servers, the one or more digital medium components being determined by at least one of the one or more third party servers based on the characteristic; and
means for generating a modified electronic communication based on the electronic communication and the one or more digital medium components.
